(19) United States
(12) Patent Application Publication
(10) Pub. No.: US 2013/0297090 A1
(43) Pub. Date: Nov. 7, 2013

(54) ELECTRICAL ENERGY DISTRIBUTION APPARATUS

(71) Applicants: Armand Michel Marie Lelkens, Heerlen (NL); Alessio Filippi, Eindhoven (NL); Maurice Herman Johan Draaijer, Ittervoort (NL); Peter Fuhrmann, Aachen (DE)

(72) Inventors: Armand Michel Marie Lelkens, Heerlen (NL); Alessio Filippi, Eindhoven (NL); Maurice Herman Johan Draaijer, Ittervoort (NL); Peter Fuhrmann, Aachen (DE)

(73) Assignee: KONINKLIJKE PHILIPS N.V., EINDHOVEN (NL)

(21) Appl. No.: 13/977,868

(22) PCT Filed: Dec. 29, 2011
(86) PCT No.: PCT/IB2011/056003

§ 371 Date: Jul. 1, 2013

(30) Foreign Application Priority Data
Jan. 6, 2011 (EP) 11150287.8

(51) Int. Cl. H02J 3/14

(52) U.S. Cl. CPC H02J 3/14
USPC 700/295

(57) ABSTRACT

The invention relates to an electrical energy distribution apparatus (1) for distributing electrical energy within an arrangement of electrical devices (3 to 7, 11). Assignments between priority classes and at least some of the electrical devices (3 to 7) are provided and distribution control information for controlling the distribution of electrical energy within the arrangement of the electrical devices (3 to 7, 11) is received. A distribution rules determination unit (9) determines distribution rules depending on the received distribution control information and the provided assignments, and an electrical energy distributor (10) distributes the electrical energy within the arrangement of electrical devices (3 to 7, 11) depending on the determined distribution rules. This determination of distribution rules depending on the assignments and the distribution control information, which may reflect, for example, actual costs of electrical energy, provides an adaptable distribution of electrical energy, which allows for improving this distribution.

### FIELD OF THE INVENTION

The invention relates to an electrical energy distribution apparatus, an electrical energy distribution method and a computer program for distributing electrical energy within an arrangement of electrical devices. The invention relates further to an electrical system comprising the electrical devices and the electrical energy distribution apparatus.

### BACKGROUND OF THE INVENTION

In a household electrical system several electrical consumers are connected to the mains grid for supplying electrical energy to the electrical consumers. Generally, the distribution of electrical energy within the arrangement of electrical consumers is independent of characteristics like the actual pricing of the electrical energy, the demand for electrical energy, et cetera, and, thus, not optimized for these characteristics.

### SUMMARY OF THE INVENTION

It is an object of the present invention to provide an electrical energy distribution method, an electrical energy distribution method and a computer program for distributing electrical energy within an arrangement of electrical devices, which allow for improving the distribution of electrical energy. It is a further object of the present invention to provide an electrical system comprising several electrical devices and the electrical energy distribution apparatus.

In a first aspect of the present invention an electrical energy distribution apparatus for distributing electrical energy within an arrangement of electrical devices is presented, wherein the electrical energy distribution apparatus comprises:

a priority providing unit for providing assignments between priority classes and at least some of the electrical devices,

a distribution control information receiving unit for receiving distribution control information for controlling the distribution of electrical energy within the arrangement of the electrical devices,

a distribution rules determination unit for determining distribution rules depending on the received distribution control information and the assignments between priority classes and the at least some of the electrical devices, wherein the distribution rules define the distribution of electrical energy within the arrangement of electrical devices,

an electrical energy distributor for distributing the electrical energy within the arrangement of electrical devices depending on the determined distribution rules.

Since the electrical devices are assigned to priority classes, wherein distribution rules are determined depending on the assignments between the priority classes and the electrical devices and distribution control information received from the distribution control information receiving unit, wherein the determined distribution rules are used for distributing the electrical energy within the arrangement of electrical devices, the distribution of electrical energy can be adapted to the respective priorities of the electrical devices and the distribution control information which may reflect, for example, costs of electrical energy, the actual demand, et cetera. This adaptability of the distribution of electrical energy within the arrangement of electrical devices allows for improving this distribution.

The electrical devices comprise preferentially at least one electrical consumer like a light source, a freezer, a washing machine, an electric car, et cetera and at least one electrical energy source like the mains grid, a battery, an electric car, a photovoltaic system, et cetera. An electric device can be an electrical consumer and an electrical energy source. For example, an electric car can be regarded as an electrical consumer during a charge procedure and can be regarded as an electrical energy source, if the electric car is used for providing electrical energy. Also the mains grid can be regarded as an electrical energy source and may also be regarded as an electrical consumer, if locally generated or stored electrical energy is sold to an energy utility.

The priority classes can be assigned to electrical consumers, to electrical energy sources or to both, electrical consumers and electrical energy sources. Correspondingly, the distribution rules can be determined for the electrical consumers only, the electrical energy sources only, or for both, the electrical consumers and the electrical energy sources.

The priority providing unit can be a storage unit, in which the assignments between priority classes and the electrical devices are stored.

The electrical energy distributor can comprise a switch for distributing the electrical energy received from one or several electrical energy sources to one or several electrical consumers depending on the determined distribution rules.

The priority classes preferentially define the preferences of providing electrical energy to the different electrical devices, if they are electrical consumers, and/or the preferences of receiving electrical energy from the electrical devices, if they are electrical energy sources.

It is preferred that the electrical energy distribution apparatus further comprises an assignment modification unit for receiving assignment modifying information and for modifying an assignment between a priority class and an electrical device depending on the received assignment modifying information. It is further preferred that the assignment modification unit is adapted to receive operational state information as the assignment modifying information, the operational state information being indicative of an operational state of the electrical device. The assignments between the priority classes and the electrical devices are therefore not static, but dynamic. By allowing for dynamically changing the assignments between electrical devices and priority classes, the distribution rules, which are determined based on the changed assignments, can be adapted to an actual or coming situation, thereby further improving the quality of distributing the electrical energy within the arrangement of electrical devices.

The assignment modification unit comprises preferentially assignment modification rules, which define to which priority class the respective electrical device has to be assigned depending on the assignment modifying information, in particular, depending on the operational state of the respective electrical device. The assignment modification unit is preferentially adapted to modify an assignment between a priority class and an electrical device depending on the received assignment modifying information and the assignment modification rules. In an embodiment, the assignment modification rules can also be used to initially define a priority class of an electrical device. For example, if the electrical energy distribution apparatus is initialized, the assignment modification rules can be used to initially assign priority classes to the electrical devices depending on, for example, the operational state of the respective electrical device, user input, et cetera. However, the initial assignments can also be predefined by, for example, the user or a manufacturer.

It is also preferred that the assignment modification unit is adapted to receive environmental information as the assignment modifying information, the environmental information being indicative of a property of the environment of the electrical device. It is further preferred that the environmental information is a presence signal from a presence sensor, the presence signal being indicative of the presence of a person in the environment of the electrical device. For example, if the electrical device is a light source for illuminating a room, the assignment modification rules can define to assign a certain higher priority class to the light source, if the presence signal indicates that a person is in the room, and to assign a certain lower priority class, if the presence signal indicates that a person is not in the room. Since the assignments of the electrical devices to the priority classes can be modified depending on environmental information, wherein the modified assignments are used for determining the distribution rules defining the distribution of the electrical energy within the arrangement of electrical devices, the distribution of energy can be adapted to environmental properties like the presence of a person, the environmental temperature if the respective electrical device is a hitting device, the environmental humidity if the respective electrical device is a device for modifying the environmental humidity like an air conditioning unit, et cetera, thereby allowing for further improving the distribution of electrical energy within the arrangement of electrical devices.

In a preferred embodiment, at least one of the electrical devices is an electrical energy source for providing electrical energy, wherein the assignment modification unit is adapted to receive pricing information as the assignment modifying information for modifying the assignment of a priority class to the at least one electrical device being an electrical energy source, the pricing information being indicative of the costs for the electrical energy from the electrical energy source. For example, if several electrical energy sources are present like a photovoltaic system, a battery and the mains grid and if the cost for the electrical energy from the mains grid increase, a lower priority class can be assigned to the mains grid such that the electrical energy from the other electrical energy sources is preferentially used for being distributed within the arrangement of electrical devices. This allows for reducing the costs for the consumed electrical energy.

It is further preferred that at least some of the electrical devices are electrical consumers, wherein the distribution rules are adapted to indicate electrical consumers to which electrical energy is to be provided such that the electrical energy is provided with higher priority to electrical consumers assigned to a higher priority class and with lower priority to electrical consumers assigned to a lower priority class. For example, the distribution rules can define a threshold, wherein electrical consumers of priority classes being higher than the threshold receive electrical energy and wherein electrical consumers of priority classes being below the threshold do not receive electrical energy. If, in an example, five priority classes are present, the distribution rules can define that, for instance, only electrical consumers of the first and second priority classes receive electrical energy.

It is also preferred that the distribution control information receiving unit is adapted to receive pricing information as the distribution control information, the pricing information being indicative of the costs for electrical energy to be distributed. It is further preferred that at least some of the electrical devices are electrical consumers, wherein the distribution rules are adapted to indicate to provide electrical energy to electrical consumers assigned only to one or several higher priority classes, if the pricing information indicates higher costs for the electrical energy, and to provide electrical energy to electrical consumers assigned also to one or several lower priority classes, if the pricing information indicates lower costs for the electrical energy. For example, the distribution rules can define a threshold, wherein electrical consumers of priority classes above the threshold receive electrical energy and wherein electrical consumers of priority classes below the threshold do not receive electrical energy. If, for example, the pricing information indicates a reduction in costs for the electrical energy, the threshold can be decreased such that now also electrical consumers of a lower priority class receive electrical energy. Correspondingly, if the pricing information indicates increasing costs for electrical energy, the threshold can be increased such that electrical consumers of priority classes, which are now below the increased threshold, do also not receive electrical energy.

In a preferred embodiment, the distribution control information receiving unit is adapted to receive upper limit information as the distribution control information, the upper limit information being indicative of an upper limit of total power consumption, which should be not exceeded. It is also preferred that at least some of the electrical devices are electrical consumers, wherein the distribution rules are adapted to indicate electrical consumers to which electrical energy is to be provided such that the total power consumption of the electrical consumers is below the upper limit and such that the electrical energy is provided with higher priority to electrical consumers assigned to a higher priority class and with lower priority to electrical consumers assigned of a lower priority class. This allows holding the total power consumption below the upper limit, wherein the electrical consumers of relatively higher priority classes receive the electrical energy preferentially. For example, if it has been agreed with an energy utility to remain below a certain total power consumption value, wherein the costs for the electrical energy are reduced below the corresponding upper limit, the costs for the electrical energy can be reduced, wherein the important electrical consumers of the higher priority classes still receive the electrical energy required by them.

It is further preferred that at least some of the electrical devices are electrical consumers, wherein the distribution rules determination unit is adapted to determine the distribution rules such that the electrical energy is always provided to electrical consumers assigned to the highest priority class. This ensures that important electrical consumers like lifesaving equipment are never switched off.

It is also preferred that the electrical energy distribution apparatus further comprises an assignment change prediction unit for determining a prediction value being indicative of a prediction of an assignment change of an assignment between a priority class and an electrical device based on prediction rules, the prediction rules defining probabilities of an assignment change depending on provided prediction information, and wherein the distribution rules determination unit is adapted to determine the distribution rules depending on the distribution control information, the assignments between priority classes and the electrical devices and the determined prediction value. Prediction information can be any information, which allows predicting future assignment changes based on the prediction rules. For example, the prediction information can be information about the current operational state of an electrical device, wherein the prediction rules define the probability of a future assignment change based on the current operational state. For example, if the prediction value indicates that an electrical device will be assigned to a higher priority class, switching on an electrical device of a lower priority class can be postponed, in order to not, for example, have to switch off the electrical device of the lower priority class or to not have to postpone switching on the electrical device of the higher priority class, after the change in assignment has been performed.

In a preferred embodiment, at least some of the electrical devices are electrical energy sources, wherein the distribution rules are adapted to indicate electrical energy sources from which electrical energy is to be provided such that the electrical energy is provided with higher priority from electrical energy sources assigned to a higher priority class and with lower priority from electrical energy sources assigned to a lower priority class. For example, the distribution rules can comprise a threshold, wherein electrical energy sources of priority classes below the threshold do not provide electrical energy and wherein electrical energy sources of priority classes above the threshold provide electrical energy. This threshold can be modified by, for example, modified distribution control information received by the distribution control information receiving unit.

In a further aspect of the present invention an electrical system is presented, wherein the electrical system comprises several electrical devices and the electrical energy distribution apparatus as defined in claim 1 for distributing electrical energy within an arrangement of the electrical devices.

In a further aspect of the present invention an electrical energy distribution method for distributing electrical energy within an arrangement of electrical devices is presented, wherein the electrical energy distribution method comprises:

providing assignments between priority classes and at least some of the electrical devices,

receiving distribution control information for controlling the distribution of electrical energy within the arrangement of the electrical devices,

determining distribution rules depending on the received distribution control information and the assignments between priority classes and the at least some of the electrical devices, wherein the distribution rules define the distribution of electrical energy within the arrangement of electrical devices,

distributing the electrical energy within the arrangement of electrical devices depending on the determined distribution rules.

In a further aspect of the present invention a computer program for distributing electrical energy within an arrangement of electrical devices is presented, wherein the computer program comprises program code means for causing an electrical energy distribution apparatus as defined in claim 1 to carry out the steps of the electrical energy distribution method as defined in claim 14, when the computer program is run on a computer controlling the electrical energy distribution apparatus.

It shall be understood that the electrical energy distribution apparatus of claim 1, the electrical system of claim 13, the electrical energy distribution method of claim 14 and the computer program of claim 15 have similar and/or identical preferred embodiments as defined in the dependent claims.

It shall be understood that a preferred embodiment of the invention can also be any combination of the dependent claims with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily an embodiment of an electrical system comprising an electrical energy distribution apparatus, several electrical consumers and an electrical energy source,

FIG. 2 shows schematically and exemplarily an embodiment of an electrical system comprising an electrical energy distribution apparatus, several electrical energy sources and an electrical consumer,

FIG. 3 shows schematically and exemplarily an embodiment of an electrical system comprising an electrical energy distribution apparatus, several electrical consumers and several electrical energy sources, and

FIG. 4 shows a flowchart exemplarily illustrating an embodiment of an electrical energy distribution method for distributing electrical energy within an arrangement of electrical devices.

### DETAILED DESCRIPTION OF EMBODIMENTS

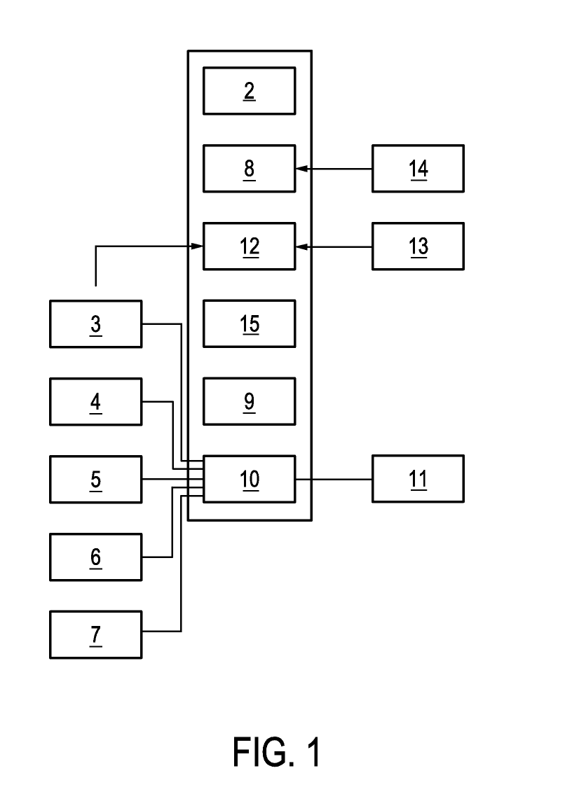

FIG. 1 shows schematically and exemplarily an embodiment of an electrical system 16 comprising several electrical devices 3 to 7, 11 and an electrical energy distribution apparatus 1 for distributing electrical energy within an arrangement of the electrical devices 3 to 7, 11. The electrical devices 3 to 7 are electrical consumers like light sources, a freezer, a washing machine, an electric car, et cetera. The electrical device 11 is, in this embodiment, the mains grid. In another embodiment, the electrical device 11 can also be another electrical energy source like a battery, a photovoltaic system, et cetera.

The electrical energy distribution apparatus 1 comprises a priority providing unit 2 for providing assignments between priority classes and at least some of the electrical devices. In this embodiment, the priority providing unit 2 provides assignments between priority classes and the electrical consumers 3 to 7. The electrical consumers 3 to 7 can be assigned to five priority classes, wherein the first class has the highest priority and the fifth class has the lowest priority. The priority classes define the preferences of providing electrical energy to the different electrical consumers 3 to 7. In particular, the priority classes indicate how urgently the electrical consumers 3 to 7 need power and thus in what order they could be switched off in case of, for example, power shortage or other power-related constraints like pricing. For example, to the first priority class electrical consumers can be assigned which shall never be switched off, or shall, when electrical energy is available, be switched on. Examples are life saving equipment. Even though they might be on uninterruptable power supply (UPS), they are always the last electrical consumers to be switched off at a power shortage. The electrical consumers assigned to the second priority class shall preferably not be switched off. Examples are real time equipment like a television, a personal computer, a personal computer monitor, task lighting in a living room, a hairdryer, et cetera.

The third priority class can be assigned to electrical consumers for which switching on can be postponed like for a washing machine. To the fourth priority class electrical consumers can be assigned which can be shut off, but probably will have to start again a while later. Examples are an air conditioning, a freezer, a fridge, et cetera. Electrical consumers, which can be switched off without problems like decorative lighting, charging of a residential storage, et cetera, can be assigned to the fifth priority class.

The priority providing unit 2 is preferentially a storage unit, in which the assignments between the priority classes and the electrical consumers are stored.

The electrical energy distribution apparatus further comprises an assignment modification unit 12 for receiving assignment modifying information and for modifying an assignment between a priority class and an electrical device depending on the received assignment modifying information. In this embodiment, the assignment modification unit 12 is adapted to receive operational state information as the assignment modifying information from the electrical devices, wherein the operational state information is indicative of an operational state of the respective electrical consumer. The assignments between the priority classes and the electrical consumers 3 to 7 are therefore not fixed or static, but dynamic. The assignment modification unit 12 comprises assignment modification rules, which define to which priority class the respective electrical consumer 3 to 7 has to be assigned depending on the assignment modifying information, in particular, depending on the operational state of the respective electrical consumer 3 to 7. The assignment modification unit 12 is adapted to modify an assignment between a priority class and an electrical device 3 to 7 depending on the received assignment modifying information and the assignment modification rules. For example, a freezer that is in the fourth class will, after being shut off, start to warm up slowly. The assignment modification rules can be defined such that, after the temperature of the freezer has reached a threshold of, for example, −20° C., the freezer is assigned to the third priority class. When reaching a critical threshold of, for example, −18° C., the assignment modification rules can define that the freezer has to be assigned to the second priority class. Similarly, when cooling down, the assignment modification rules can define that the freezer has to be assigned to the third priority class and then to the fourth priority class. As a further example, initially and, for instance, when loaded and programmed, a washing machine can be assigned to the third priority class. The assignment modification rules can define that, as soon as the washing machine has really started, it changes to the second priority class, thus lowering the risk of interrupting its operation. In a further example, the electrical consumer is an electric car, and the assignment modification rules can define that while charging, the charger of the car batteries can be in the first priority class or the second priority class depending on the requirements to ensure a proper battery lifetime. The assignment modification rules can further define that the charger is assigned to a lower priority class, if the battery of the electric car is full or almost full, for example, charged to at least 90%. In a further example, the electrical consumer is a lighting system having a preset of certain settings for several luminaires of the lighting system. One or several of these settings could be labeled cosy or guests and, thus, be related to a higher priority class. For instance, the operational state could indicate the current settings of the lighting system, wherein the assignment modification rules can be adapted to assign the lighting system to higher priority class, if the current settings are labeled cosy or guests. In another embodiment, the assignment modification unit is adapted to analyze the power consumption at a central place, in particular, the total power consumption of the electrical devices at a central place, and to perform a power disaggregation method for determining which electrical device is in which operational state from the power consumption. Preferentially, electrical signatures of the operational states of the electrical devices are used for determining which electrical device is in which operational state. In this case, the measured power consumption can be regarded as assignment modification information, wherein the assignment modification unit is adapted to determine the operational states from the power consumption and to modify the assignments based on the determined operational states and based on the assignment modification rules.

The assignment modification unit 12 is preferentially further adapted to receive environmental information as the assignment modifying information, wherein the environmental information is indicative of a property of the environment of the respective electrical consumer 3 to 7. In this embodiment, the assignment modification unit 12 receives a presence signal from a presence sensor 13, wherein the presence signal is indicative of the presence of a person in the environment of the respective electrical consumer. The presence signal can be used to assign an electrical consumer, which is generally used only, if a person is present in the environment of the respective electrical consumer, to a lower priority class, if the presence signal indicates that a person is not present in the environment of the respective electrical consumer. For example, if the electrical consumer is a light source for illuminating a room, the assignment modification rules can define to assign a certain higher priority class to the light source, if the presence signal indicates that a person is in the room, and to assign a certain lower priority class, if the presence signal indicates that a person is not in the room. In particular, initially the light source can be assigned to the second priority class. However, the assignment modification rules can be adapted such that, if no presence is detected in the room or nearby the room, which is illuminated by the light source, for some predefined time interval, the light source is assigned to the fourth or fifth priority class. If the light source is assigned to the fourth or fifth priority class, the room may be illuminated, even if a person is not in or nearby the room, in order to, for example, simulate the presence of a person in a room at home, even if a person is not at home. As the person is back at home, the presence of the person may be detected by the presence detector 13 and the assignment modification rules can define that the light source is assigned again to a higher priority class, for example, to the second priority class. As a further example, if a television or computer monitor is switched on and assigned to the second priority class and the presence signal indicates that a person has left the environment, for instance, a room in which the television or computer monitor is located, the television or computer monitor can be assigned to a lower priority class as may be defined by the assignment modification rules. In addition or alternatively, the electrical energy distribution apparatus can comprise a user interface for allowing a user to enter assignment modification information, in particular, to manually override an assignment. For example, if the user has guests, the user can enter assignment modification information indicating that the user has guests and the assignment modification rules can define for this case that light sources illuminating certain rooms, in particular, decorative lighting, should be assigned to a higher priority class.

Moreover, the assignment modification unit can be adapted to receive assignment modification information from a home wireless network system, wherein this assignment modification information can indicate whether an unusual device, in particular, an unusual WLAN device, is or tries to be associated with the home wireless network system. In this case, it can be assumed that a guest is in the home and the assignment modification rules can define that, for example, decorative lighting should be moved to a higher priority class, for instance, from the fifth priority class to the third priority class.

The electrical energy distribution apparatus 1 further comprises a distribution control information receiving unit 8 for receiving distribution control information for controlling the distribution of electrical energy within the arrangement of the electrical devices 3 to 7, 11 and a distribution rules determination unit 9 for determining distribution rules depending on the received distribution control information and the assignments between priority classes and the electrical consumers 3 to 7, wherein the distribution rules define the distribution of electrical energy within the arrangement of electrical devices 3 to 7, 11. The electrical energy is then distributed within the arrangement of electrical devices 3 to 7, 11 depending on the determined distribution rules by an electrical energy distributor 10. The electrical energy distributor 10 comprises a switch for distributing the electrical energy received from the mains grid 11 to one or several of the electrical consumers 3 to 7 depending on the determined distribution rules.

The distribution rules are adapted to indicate electrical consumers 3 to 7 to which electrical energy is to be provided such that the electrical energy is provided with higher priority to electrical consumers assigned to a higher priority class and with lower priority to electrical consumers assigned to a lower priority class. For example, the distribution rules can define a threshold, wherein electrical consumers of priority classes being higher than the threshold are provided with electrical energy and wherein electrical consumers of priority classes below the threshold are not provided with the electrical energy. The threshold can define, for example, that only electrical consumers of the first and second priority classes receive electrical energy, but not electrical consumers of the third to fifth priority classes.

In this embodiment, the distribution control information receiving unit 8 is adapted to receive pricing information as the distribution control information, wherein the pricing information is indicative of the costs of electrical energy to be distributed. For example, the distribution control information receiving unit 8 can receive the pricing information from the energy utility via the Internet indicated in FIG. 1 by the box 14. The distribution rules are adapted to indicate to provide electrical energy to electrical consumers assigned only to one or several higher priority classes, if the pricing information indicates higher costs for the electrical energy, and to provide electrical energy to electrical consumers assigned also to one or several lower priority classes, if the pricing information indicates lower costs for the electrical energy. For example, the distribution rules can define a threshold, wherein electrical consumers of priority classes above the threshold receive electrical energy and wherein electrical consumers of priority classes below the threshold do not receive electrical energy. If the pricing information indicates a reduction in costs for the electrical energy, the threshold can be decreased such that now also electrical consumers of a lower priority class receive electrical energy. Correspondingly, if the pricing information indicates increasing costs for electrical energy, the threshold can be increased such that electrical consumers of priority classes, which are now below the increased threshold, do also not receive electrical energy.

Alternatively or in addition, the distribution control information receiving unit 8 can receive upper limit information as the distribution control information, wherein the upper limit information is indicative of an upper limit of total power consumption, which should not be exceeded. The distribution rules are then adapted to indicate electrical consumers to which electrical energy is to be provided such that the total power consumption of the electrical consumers is below the upper limit and such that the electrical energy is provided with higher priority to electrical consumers assigned to a higher priority class and with lower priority to electrical consumers assigned to a lower priority class. This allows holding the total power consumption below the upper limit, wherein the electrical consumers of relatively higher priority classes receive the electrical energy preferably. For example, if it has been agreed with an energy utility to remain below a certain total power consumption value, wherein the costs for electrical energy are reduced below the corresponding upper limit, the costs for the electrical energy can be reduced, wherein the important electrical consumers of the higher priority classes still surely receive the electrical energy required by them. Thus, if an agreement with the energy utility mentions an upper limit for the total power consumption, the central unit, i.e. the electrical energy distribution apparatus 1, decides which device to shut down in order to avoid the total power consumption being more than the agreement allows. However, in this embodiment with the upper limit and also in the other embodiments the distribution rule determination unit is preferentially adapted to determine the distribution rules such that the electrical energy is always provided to electrical consumers assigned to the highest priority class, in order to ensure that important electrical consumers like life saving equipment are never switched off.

The electrical energy distribution apparatus 1 further comprises an assignment change prediction unit 15 for determining a prediction value being indicative of a prediction of an assignment change of an assignment between a priority class and an electrical device based on prediction rules, wherein the prediction rules define probabilities of an assignment change depending on provided prediction information being, for example, the operational state of the electrical device. Correspondingly, the distribution rules determination unit 9 can be adapted to consider also the prediction values while determining the distribution rules. For example, if the prediction value indicates that an electrical device will be assigned to a higher priority class, switching on an electrical device of a lower priority class can be postponed, in order to not, for example, have to switch off the electrical device of the lower priority class or to not have to postpone switching on the electrical device of the higher priority class, after the change in assignment has been performed. The assignment change prediction unit can therefore predict changes in the priority map, i.e. in the assignments between electrical devices and priority classes, by forecasting expected priority changes for a relevant time period. For instance, the transitions for a freezer application could be forecasted with a certain probability, for example, for time windows defined by critical peak pricing or time of use schemes. By including probabilities for priority changes for known applications, the energy management can be further optimized such that the elevation and scheduling for power supply of low priority applications is postponed, if a high priority transition event can be expected.

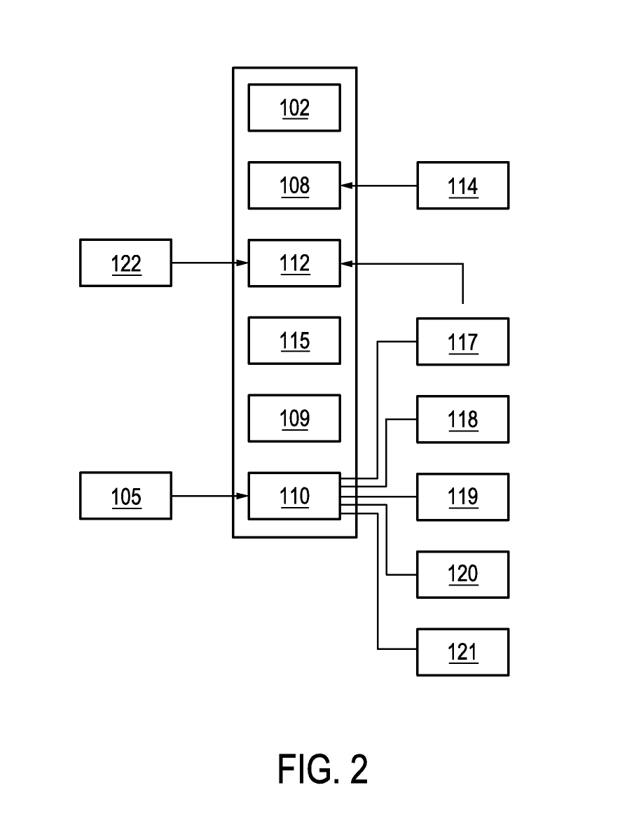

FIG. 2 shows schematically and exemplarily a further embodiment of an electrical system 116 comprising several electrical devices 105, 117 to 121 and an electrical energy distribution apparatus 101. In this embodiment, the electrical device 105 is an electrical consumer like a light source, a freezer, a washing machine, et cetera and the electrical devices 117 to 121 are electrical energy sources. The electrical energy distribution apparatus 101 comprises a priority providing unit 102 for providing assignments between priority classes and the electrical energy sources 117 to 121. Also in this embodiment the priority providing unit 102 can be a storage unit for storing the assignments between the priority classes and the electrical energy sources 117 to 121. The priority classes define the preferences of receiving electrical energy from the electrical energy sources 117 to 121. The electrical energy sources 117 to 121 are, for example, the mains grid, one or several batteries, an electric car, a photovoltaic system, et cetera.

The electrical energy distribution apparatus 101 further comprises a distribution control information receiving unit 108 for receiving distribution control information for controlling the distribution of electrical energy within the arrangement of electrical devices 105, 117 to 121. In particular, in this embodiment the distribution control information can be used for controlling which electrical energy sources provide electrical energy to the electrical consumer 105.

The electrical energy distribution apparatus 101 further comprises a distribution rules determination unit 109 for determining distribution rules depending on the received distribution control information and the assignments between priority classes and the electrical energy sources 117 to 121, wherein the distribution rules define the distribution of electrical energy within the arrangement of electrical devices 105, 117 to 121. In this embodiment, the distribution rules define which electrical energy sources provide electrical energy to the electrical consumer 105. An electrical energy distributor 110 then distributes the electrical energy from the one or several electrical energy sources 117 to 121 to the electrical consumer 105 in accordance with the determined distribution rules.

The distribution rules are adapted to indicate electrical energy sources from which electrical energy is to be provided such that the electrical energy is provided with higher priority from electrical energy sources assigned to a higher priority class and with lower priority from electrical energy sources assigned to a lower priority class. For example, the distribution rules can comprise a threshold, wherein electrical energy sources of priority classes below the threshold do not provide electrical energy and wherein electrical energy sources above the threshold provide electrical energy. This threshold can be modified by, for example, the distribution control information received by the distribution control information receiving unit 108. The distribution control information can, for example, indicate the threshold, wherein the distribution control information can be set by, for instance, a user interface 114, in order to allow a user to modify the threshold.

Also in this embodiment, the electrical energy distribution apparatus comprises an assignment modification unit 112 for receiving assignment modifying information and for modifying an assignment between a priority class and an electrical energy source 117 to 121 depending on the received assignment modifying information. For example, the assignment modifying information can be pricing information received, for instance, via the Internet indicated in FIG. 2 by the box 122. The pricing information is indicative of the costs for the electrical energy of at least one of the electrical energy sources 117 to 121. For example, the pricing information can be indicative of the costs for the electrical energy from a mains grid being one of the electrical energy sources. If the costs for the electrical energy from the mains grid increase, a lower priority class can be assigned to the mains grid such that the electrical energy from the other electrical energy sources is preferentially used for being distributed within the arrangement of electrical devices. This allows for reducing the costs for the consumed electrical energy.

Also in this embodiment described with reference to FIG. 2 the assignment modification unit 112 comprises assignment modification rules, which define to which priority class the respective electrical energy source has to be assigned depending on the assignment modifying information, in particular, depending on the pricing information. Also information regarding the operational state of the respective electrical energy source can be used for modifying the assignments between the electrical energy sources and the priority classes. For example, for a battery the assignment modifying information can be indicative of the charge status of the battery, wherein the assignment modification rules can define that the battery should be assigned to a higher priority class, if the charge status is above a charge threshold, and that the battery should be assigned to a lower priority class, if the charge status is below the threshold.

The electrical energy distribution apparatus 101 further comprises an assignment change prediction unit 115 for determining a prediction value being indicative of a prediction of an assignment change of an assignment between a priority class and an electrical energy source 117 to 121 based on prediction rules, wherein the prediction rules define probabilities of an assignment change depending on provided prediction information being, in this embodiment, the operational state of the electrical energy source 117 to 121. Correspondingly, the distribution rules determination unit 109 is adapted to determine the distribution rules also depending on the determined prediction values.

The electrical energy distribution apparatus 101 provides therefore a class scheme for energy sources, where the priority class indicates the preference which electrical energy source to use. The mains grid is preferentially one electrical energy source and the further electrical energy sources are, for example, local storage devices like a UPS, an electric car, et cetera and generators like a wind-based generator, a photovoltaic system, et cetera. The generators, of which the energy would be wasted if not used, are preferentially assigned to the highest priority class. The priority class of the mains grid can be adapted depending on its price and preferentially on the way this is expected to change in the short term. The price can be provided as assignment modifying information and the prediction of the price changes can be provided as a prediction value, wherein in this case the assignment change prediction unit 115 may just receive the prediction via, for example, the Internet. The priority class of the local storage devices can depend on their charge status, i.e. their operational state, and preferentially anticipated short term usage requirement, which can be provided as a prediction value. If energy prices go up, the priority class of the mains grid electricity will decrease and locally stored electricity will thus get preference over electricity from the mains grid. In this way the local energy storage can be balanced in an optimum way.

The mains grid can also be classified as an electrical consumer, where locally generated or stored energy is sold to the energy utility. The priority class of this electrical consumer being the mains grid then changes with the price the energy utility pays for the electricity it receives.

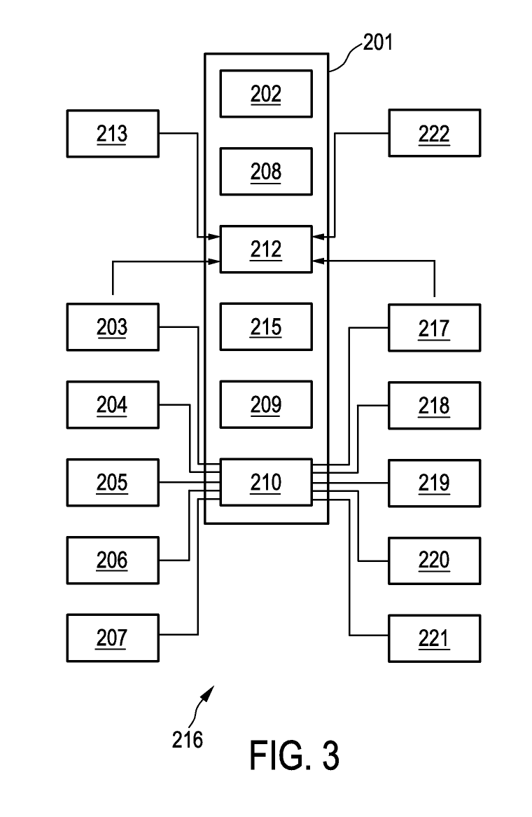

FIG. 3 shows schematically and exemplarily a further embodiment of an electrical system 216. The electrical system 216 comprises an electrical energy distribution apparatus 201, several electrical consumers 203 to 207 and several electrical energy sources 217 to 221.

The electrical energy distribution apparatus 201 comprises a priority providing unit 202 for providing assignments between priority classes and the electrical consumers 203 to 207 and the electrical energy sources 217 to 221. Thus, both, the electrical consumers 203 to 207 and the electrical energy sources 217 to 221, are assigned to priority classes. The electrical energy distribution apparatus 201 further comprises a distribution control information receiving unit 208, an assignment modification unit 212, an assignment change prediction unit 215 and a distribution rules determination unit 209. These units and the electrical energy distributor 210 correspond to the units described above with reference to FIGS. 1 and 2, wherein in the embodiment described with reference to FIG. 3, the units do not only refer to the electrical consumers or the electrical energy sources, but to both, the electrical consumers and the electrical energy sources. Also in this embodiment, a presence sensor 213 can be used for generating a presence signal being indicative of the presence of a person in the environment of a respective electrical consumer like a light source, wherein the presence signal can be regarded as assignment modifying information for the respective electrical consumer. Moreover, the assignment modification unit 212 can receive pricing information from, for example, the Internet indicated in FIG. 3 by the box 222, wherein, for instance, the priority class of a mains grid can be modified depending on the pricing information, i.e. also the pricing information can be regarded as being assignment modifying information.

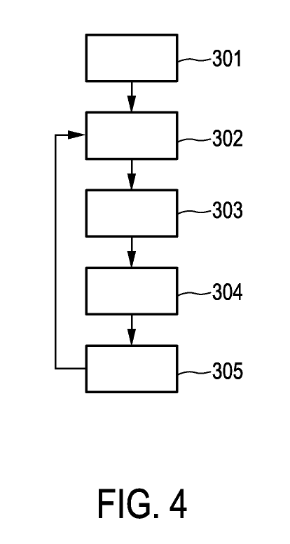

In the following an embodiment of an electrical energy distribution method will exemplarily be described with reference to a flowchart shown in FIG. 4.

In step 301, assignments between priority classes and electrical devices are provided, and, in step 302, distribution control information for controlling the distribution of electrical energy within an arrangement of the electrical devices is received. The distribution control information is, for example, pricing information being indicative of the costs for electrical energy from, for example, a mains grid. In step 303, assignment modifying information is received and assignments between priority classes and electrical devices are modified depending on the received assignment modifying information. In particular, operational state information being indicative of an operational state of a respective electrical device is received and the priority class of the electrical device is modified depending on the received operational state information. In step 304, distribution rules are determined depending on the received distribution control information and the assignments between priority classes and electrical devices, wherein the distribution rules define the distribution of electrical energy within the arrangement of electrical devices. In step 305, the electrical energy is distributed within the arrangement of electrical devices depending on the determined distribution rules. Steps 302 to 305 can be performed in a closed loop. Optionally, also prediction values being indicative of a prediction of an assignment change of an assignment between a priority class and an electrical device can be determined, wherein, in this case, in step 304 the distribution rules are determined also depending on the prediction values.

The price of electricity does not only depend on cost of resources, but is also matter of supply versus demand. Fluctuations in demand can give rise to huge changes in cost as, for example, in case a power plant needs to be powered up to meet demand. Normally, demand varies heavily during the day and shaving off peaks by moving demand from peak times to low-demand times can lead to huge savings.

Peak shaving is in principle a good idea, but the operation of devices cannot always simply be delayed without affecting comfort. Some devices will simply have to respond to a user immediately like a television set, whereas others might be programmed to start later like a washing machine or to be switched off for a period of time, in particular, a short period of time, like a freezer. The embodiments of the electrical energy distribution apparatus described above with reference to FIGS. 1 to 3 employ a dynamic priority scheme which preferentially allows shifting power consumption with minimal effect on user comfort and which preferentially accounts for changes in the availability of appliances for demand side management applications.

Although in the above described embodiments the electrical energy distribution apparatus comprises the assignment modification unit for modifying an assignment between a priority class and an electrical device, the electrical device itself can also be adapted to change its priority class, which is then reported to the priority providing unit, in which the assignments between the priority classes and the electrical devices are preferentially stored for being provided to the distribution rules determination unit for determining the distribution rules. Thus, the electrical device itself can be in charge and report when its situation becomes critical and leads to a change in its assignment to a respective priority class. The priorities can therefore be set by the electrical devices and the distribution of the electrical energy, i.e. the distribution of the power, can be determined by the central unit being the electrical energy distribution apparatus based on the priority classes of the electrical devices. If the electrical devices themselves change their priority class, the electrical energy distribution apparatus does preferentially not comprise the assignment modification unit. Thus, the electrical devices can be adapted to send their priority classes, in particular, their new modified priority classes and, thus, the assignments between the electrical devices and the priority classes and optionally also their power needs to the electrical energy distribution apparatus, wherein the distribution rules determination unit can be adapted to determine the distribution rules depending on the sent assignments, the distribution control information and optionally the sent power needs.

For sending information to the electrical energy distribution apparatus the electrical devices can be adapted to use the electrical connection between the respective electrical device and the electrical energy distribution apparatus and/or wireless or wired data connections.

The electrical energy distribution apparatus and method are preferentially adapted to use, besides absolute power requirements, a priority scheme to choose appliances, i.e. electrical consumers, that will be powered on or off. The priority classes indicate the urgency of each device to be powered, given the current power demand, and power supply, in particular, given the pricing of the power supply. Preferentially, depending on the state of an electrical device it can dynamically change its priority class to reflect its changing urgency in power requirements. After each change in priority class of any electrical device and/or change in pricing of the power supply, it can be decided which electrical devices shall be powered. The priority classes can reflect current needs of appliances, but can also reflect predictions for a given time period such that certain functions/applications are maintained for the required duration once started.

The electrical energy distribution apparatus and method can have knowledge about the future usage of, for example, an electric car. For instance, the decision when the batteries of the electric car are charged enough and can thus moved to a low priority class, for example, move to the fifth priority class, can depend on an envisaged requirement, for example, distance to travel, for the next day. The envisaged requirement can be regarded as being a prediction value and can be determined, for example, depending on knowledge about usual use of the electric car and the actual time. The knowledge about usual use can define prediction rules of the electric car and the actual time can be regarded as prediction information. For example, if it is known that the electric car is used Monday morning at 8:00 am for driving to work, wherein the distance to the work is known, the prediction value can be this distance or a charge status required for driving to work and back to home.

The electrical energy distribution apparatus and method are preferentially adapted for allowing electrical devices to exchange their priority classes and power requirements with a central unit, which may comprise a gateway connected to a smart meter, that compares power requirements with electricity pricing. This pricing could be fixed, for example, for a certain period of time, or dynamic, where actual pricing information is received from the energy utility via a communication link, for example, via the Internet. Pricing might be a fixed tariff, for instance, per kW, or a differentiated one, for instance, different prices per kW depending on the actual usage and a higher tariff for higher power consumption for encouraging peak shifting. The central unit can be adapted to constantly match demand as received from the devices with the supply, in particular, with tariffs. As an option, the electrical devices may not only autonomously change their priority class, but may also have a user interface to manually set the respective priority class.

The electrical energy distribution apparatus and method can be used in a residential context, wherein it is referred to home appliances and loads, but the electrical energy distribution apparatus and method can also be applicable for commercial building management. The dynamic priority handling could, for example, account for changes in the actual use of building areas like meeting rooms, unoccupied offices, et cetera, or the criticality of cooling needs, similar to the afore mentioned freezer application, in order to adapt the priority setting accordingly. Additional information about heating or cooling certain rooms can be obtained from used booking systems, for example, for meeting rooms, and calendar systems, for example, for normal office rooms. This information can be regarded as assignment modification information, wherein the assignment modification rules can define which priority class should be assigned to a heating and/or cooling system for heating and/or cooling the respective room depending on the assignment modification information. The electrical energy distribution apparatus provides preferentially a central management instance comprising a priority list, which includes the assignments between the priority classes and the electrical devices, and executing energy management control according to known, but dynamically changing, constraints. The electrical energy distribution apparatus can further comprise electrical device/application profiles, which can be regarded as being prediction rules, like some static information known a priori, other usage-dependent information, which can be gathered or announced by the electrical devices online, in order to allow the assignment change prediction unit to determine a prediction value being indicative of a prediction of an assignment change of an assignment between a priority class and an electrical device. An electrical device profile, i.e. a prediction rule, indicates, for example, that, if an electrical car has to be used within the next two hours, the charge of the battery of the electric car should have a relatively high priority. The electrical energy distribution apparatus preferentially further comprises a control or override input measure for a user, in order to enabling permanent or adapted setting of user preferences.

Although in the above described embodiments, the electrical devices are assigned to a certain number of priority classes, the electrical devices can also be assigned to another number of priority classes. Also main priority classes and sub priority classes can be defined. For example, sub priority classes can be used to extend the priority class scheme flexibly beyond the above exemplarily mentioned five priority classes in cases where this division may be too coarse. For instance, sub priority class 7 in main priority class 4 can be indicated by 4.7, wherein the sub priority class 4.7 may have preference over sub priority classes 4.8, 4.9, 4.10, . . . as well over all priority classes 5.x.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Provisions like the provision of the priority providing unit, modifications like the modifications of assignments between electrical devices and priority classes, determinations like the determination of distribution rules, et cetera, performed by one or several units or devices can be performed by any other number of units or devices. For example, steps 301 to 305 can be performed by a single unit or by any other number of different units. The provisions, modifications, determinations and/or the control of the electrical energy distribution apparatus in accordance with the electrical energy distribution method can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

The invention relates to an electrical energy distribution apparatus for distributing electrical energy within an arrangement of electrical devices. Assignments between priority classes and at least some of the electrical devices are provided and distribution control information for controlling the distribution of electrical energy within the arrangement of the electrical devices is received. A distribution rules determination unit determines distribution rules depending on the received distribution control information and the provided assignments, and an electrical energy distributor distributes the electrical energy within the arrangement of electrical devices depending on the determined distribution rules. This determination of distribution rules depending on the assignments and the distribution control information, which may reflect, for example, actual costs of electrical energy, provides an adaptable distribution of electrical energy, which allows for improving this distribution.

1. An electrical energy distribution apparatus for distributing electrical energy within an arrangement of electrical devices, the electrical energy distribution apparatus comprising:
a priority providing unit for providing assignments between priority classes and at least some of the electrical devices,
a distribution control information receiving unit for receiving distribution control information for controlling the distribution of electrical energy within the arrangement of the electrical devices,
a distribution rules determination unit for determining distribution rules depending on the received distribution control information and the assignments between priority classes and the at least some of the electrical devices, wherein the distribution rules define the distribution of electrical energy within the arrangement of electrical devices,
an electrical energy distributor for distributing the electrical energy within the arrangement of electrical devices depending on the determined distribution rules, wherein the electrical energy distribution apparatus further comprises an assignment modification unit for receiving assignment modifying information and for modifying an assignment between a priority class and an electrical device depending on the received assignment modifying information and wherein the assignment modification unit is adapted to receive operational state information as the assignment modifying information, the operational state information being indicative of an operational state of the electrical device.

2. (canceled)

3. (canceled)

4. The electrical energy distribution apparatus as defined in claim 1, wherein the assignment modification unit is adapted to receive environmental information as the assignment modifying information, the environmental information being indicative of a property of the environment of the electrical device.

5. The electrical energy distribution apparatus as defined in claim 4, wherein the environmental information is a presence signal from a presence sensor, the presence signal being indicative of the presence of a person in the environment of the electrical device.

6. The electrical energy distribution apparatus as defined in claim 1, wherein at least one of the electrical devices is an electrical energy source for providing electrical energy, wherein the assignment modification unit is adapted to receive pricing information as the assignment modifying information for modifying the assignment of a priority class to the at least one electrical device being an electrical energy source, the pricing information being indicative of the costs for the electrical energy from the electrical energy source.

7. The electrical energy distribution apparatus as defined in claim 1, wherein at least some of the electrical devices are electrical consumers, wherein the distribution rules are adapted to indicate electrical consumers to which electrical energy is to be provided such that the electrical energy is provided with higher priority to electrical consumers assigned to a higher priority class and with lower priority to electrical consumers assigned of a lower priority class.

8. The electrical energy distribution apparatus as defined in claim 1, wherein the distribution control information receiving unit is adapted to receive pricing information as the distribution control information, the pricing information being indicative of the costs for electrical energy to be distributed.

9. The electrical energy distribution apparatus as defined in claim 1, wherein the distribution control information receiving unit is adapted to receive upper limit information as the distribution control information, the upper limit information being indicative of an upper limit of total power consumption, which should be not exceeded.

10. The electrical energy distribution apparatus as defined in claim 1, wherein at least some of the electrical devices are electrical consumers and wherein the distribution rules determination unit is adapted to determine the distribution rules such that the electrical energy is always provided to electrical consumers assigned to the highest priority class.

11. The electrical energy distribution apparatus as defined in claim 1, wherein the electrical energy distribution apparatus further comprises an assignment change prediction unit for determining a prediction value being indicative of a prediction of an assignment change of an assignment between a priority class and an electrical device based on prediction rules, the prediction rules defining probabilities of an assignment change depending on provided prediction information, and wherein the distribution rules determination unit is adapted to determine the distribution rules depending on the distribution control information, the assignments between priority classes and the electrical devices and the determined prediction value.

12. The electrical energy distribution apparatus as defined in claim 1, wherein at least some of the electrical devices are electrical energy sources, wherein the distribution rules are adapted to indicate electrical energy sources from which electrical energy is to be provided such that the electrical energy is provided with higher priority from electrical energy sources assigned to a higher priority class and with lower priority from electrical energy sources assigned to a lower priority class.

13. An electrical system comprising several electrical devices and the electrical energy distribution apparatus as defined in claim 1 for distributing electrical energy within an arrangement of the electrical devices.

14. An electrical energy distribution method for distributing electrical energy within an arrangement of electrical devices, the electrical energy distribution method comprising:
providing assignments between priority classes and at least some of the electrical devices,
receiving distribution control information for controlling the distribution of electrical energy within the arrangement of the electrical devices,
determining distribution rules depending on the received distribution control information and the assignments between priority classes and the at least some of the electrical devices, wherein the distribution rules define the distribution of electrical energy within the arrangement of electrical devices,
distributing the electrical energy within the arrangement of electrical devices depending on the determined distribution rules.

15. A computer program for distributing electrical energy within an arrangement of electrical devices, the computer program comprising program code means for causing an electrical energy distribution apparatus as defined in claim 1 to carry out the steps of the electrical energy distribution method, when the computer program is run on a computer controlling the electrical energy distribution apparatus.
